(19) United States
(12) Patent Application Publication
(10) Pub. No.: US 2018/0295962 A1
(43) Pub. Date: Oct. 18, 2018

(54) NON-SLIP TELEPHONE CORD HAIR TIE

(71) Applicant: Ling Zhang, Dongguan City (CN)

(72) Inventor: Ling Zhang, Dongguan City (CN)

(21) Appl. No.: 15/488,531

(22) Filed: Apr. 17, 2017

(51) Int. Cl. A45D 8/34; B05D 5/00; B29C 65/02; B29C 65/00; B29C 37/00

(52) U.S. Cl. CPC A45D 8/34; B05D 5/00; B29C 65/02; A45D 2008/004; B29C 66/431; B29C 37/0025; B29C 66/71

(57) ABSTRACT

A non-slip telephone cord hair tie includes an elastic body. The elastic body is wound in the form of a telephone cord. Two ends of the elastic body are connected to each other to form an annular shape. The elastic body is provided with an anti-slip rib thereon. The elastic body is wound in the form of a telephone cord instead of a conventional hair band, thereby increasing the elasticity without injuring the hair. When the hair is tied up, the winding space between the telephone cord will be interposed between the bundled hair so that the hair after tied looks more.

### FIELD OF THE INVENTION

The present invention relates to a hair tie, and more particularly to a non-slip telephone cord hair tie.

### BACKGROUND OF THE INVENTION

A traditional hair band is composed of a rubber band and a woven rope, such as cloth, silk, thread or the like, wrapped on the rubber band. Both ends of the rubber band are bonded by polyester glue. The woven rope on the rubber band can be produced according to preferences for a variety of colors, so that the hair band looks more beautiful and attractive. But it has the following drawbacks: first, the rubber band is easy to disengage from the woven rope; second, both ends of the woven rope are easily parted to affect the effect and the service life of the tie band; third, if the hair is tied too tightly, the hair band may damage the hair; if the hair is tied too loosely, the bundled hair may loosen.

Accordingly, the inventor of the present invention has devoted himself based on his many years of practical experiences to solve these problems.

### SUMMARY OF THE INVENTION

In view of the shortcomings of the prior art, the primary object of the present invention is to provide a non-slip telephone cord hair tie. The non-slip telephone cord hair tie is easy to produce, and has an anti-slip function, and won't fall after the hair is tired up.

In order to achieve the aforesaid object, the non-slip telephone cord hair tie of the present invention comprises an elastic body. The elastic body is wound in the form of a telephone cord. Two ends of the elastic body are connected to each other to form an annular shape. The elastic body is provided with an anti-slip rib thereon.

Preferably, the elastic body has a semicircular cross-section. The anti-slip rib is configured to cover a top of the cross-section. The anti-slip rib protrudes from the top of the cross-section.

Preferably, the elastic body is mad of transparent PVC (polyvinyl chloride). The anti-slip rib is made of a silicone material. The anti-slip rib is integrally formed on the elastic body by dispensing.

Preferably, the two ends of the elastic body are joined by means of melt.

Compared to the prior art, the present invention has obvious advantages and beneficial effects. Specifically, the non-slip telephone cord hair tie comprises the elastic body and the anti-slip rib. The elastic body is wound in the form of a telephone cord. The two ends of the elastic body are connected to each other to form an annular shape. The elastic body is provided with the anti-slip rib thereon. The elastic body is wound in the form of a telephone cord instead of a conventional hair band, thereby increasing the elasticity without injuring the hair. When the hair is tied up, the winding space between the telephone cord will be interposed between the bundled hair so that the hair after tied looks more. Besides, the elastic body is provided with the anti-slip rib to increase the friction with the hair, having an anti-slip function, such that the hair won't fall after tired up.

### BRIEF DESCRIPTION OF THE DRAWINGS

FIG. 1 is a perspective view in accordance with a preferred embodiment of the present invention;

FIG. 2 is a schematic view in accordance with the preferred embodiment of the present invention, showing that both ends of the hair tie are not bound; and

FIG. 3 is a cross-sectional view in accordance with the preferred embodiment of the present invention.

### DETAILED DESCRIPTION OF THE PREFERRED EMBODIMENTS

Embodiments of the present invention will now be described, by way of example only, with reference to the accompanying drawings.

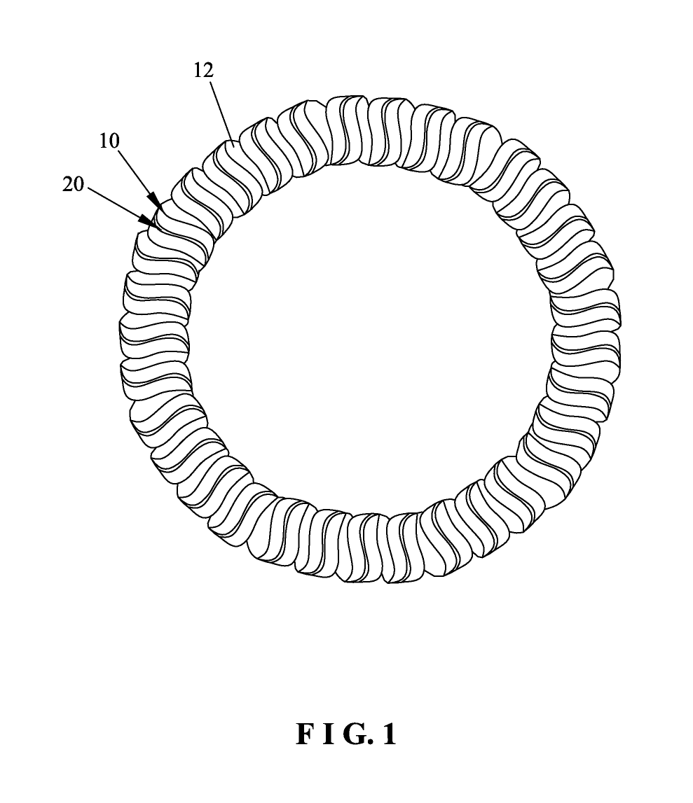

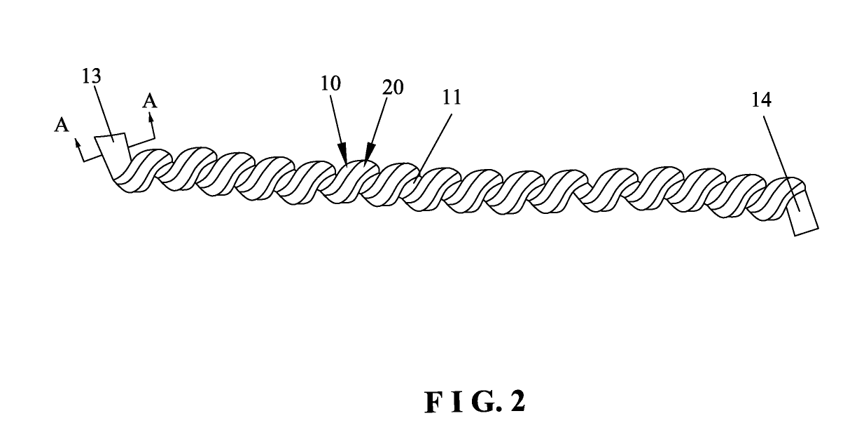

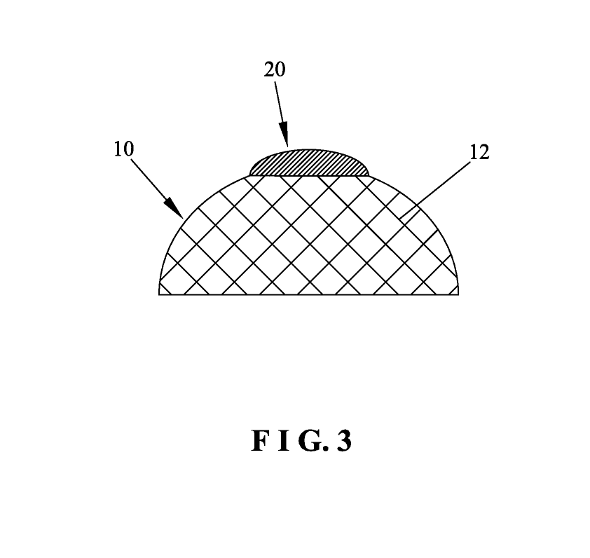

As shown in FIG. 1 to FIG. 3, the present invention disclosures a non-slip telephone cord hair tie. The non-slip telephone cord hair tie comprises an elastic body 10. The elastic body 10 is wound in the form of a telephone cord. Two ends 13, 14 of the elastic body 10 are connected to each other to form an annular shape. The elastic body 10 is provided with an anti-slip rib 20 thereon. The elastic body 10 is wound in the form of a telephone cord instead of a conventional hair band, thereby increasing the elasticity without injuring the hair. When the hair is tied up, the winding space 11 between the telephone cord will be interposed between the bundled hair so that the hair after tied looks more. Besides, the elastic body 10 is provided with the anti-slip rib 20 to increase the friction with the hair, having an anti-slip function, such that the hair won't fall after tired up.

The elastic body 10 has a semicircular cross-section 12. The anti-slip rib 20 is configured to cover the top of the cross-section 12. The anti-slip rib 20 protrudes from the top of the cross-section 12. In this way, the anti-slip rib 20 is exposed out of the elastic body 10 to get contact with the hair sufficiently to achieve an anti-slip effect. In addition, the semicircular cross-section 12 of the elastic body 10 is designed to facilitate the formation of the shape of the telephone cord. This is beneficial for the production of the hair tie and is easily shaped after winding. The shape of the semicircular cross-section 12 has an anti-friction effect.

In this embodiment, the elastic body 10 is mad of PVC (polyvinyl chloride). The anti-slip rib 20 is made of a silicone material. In the specific production, the elastic body 10 may be transparent, and the anti-slip rib 20 is in a bright color. The two are in stark contrast to each other. When the hair is tired up, it is more beautiful and attractive.

Further, the two ends 13, 14 of the elastic body 10 are joined by means of melt to be seamlessly connected, so that the hair won't be jammed by the hair tie. In addition, the connection way does not require glue and can reduce the cost. The traditional way uses glue to bind both ends of a hair tie, which may generate a stimulus odor to damage the workers' health and fill plant environment. There is no such problem with the use of melt bonding. The present invention can increase the bonding strength, and can reduce the fracture at the junction of both ends of the hair tie.

In view of the above, the feature of the present invention is that the non-slip telephone cord comprises the elastic body 10 and the anti-slip rib 20. The elastic body 10 is wound in the form of a telephone cord. The two ends 13, 14 of the elastic body 10 are connected to each other to form an annular shape. The elastic body 10 is provided with the anti-slip rib 20 thereon. The elastic body 10 is wound in the form of a telephone cord instead of a conventional hair band, thereby increasing the elasticity without injuring the hair. When the hair is tied up, the winding space 11 between the telephone cord will be interposed between the bundled hair so that the hair after tied looks more. Besides, the elastic body 10 is provided with the anti-slip rib 20 to increase the friction with the hair, having an anti-slip function, such that the hair won't fall after tired up.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. Anon-slip telephone cord hair tie, comprising an elastic body, the elastic body being wound in the form of a telephone cord, two ends of the elastic body being connected to each other to form an annular shape, the elastic body being provided with an anti-slip rib thereon.

2. The non-slip telephone cord hair tie as claimed in claim 1, wherein the elastic body has a semicircular cross-section, the anti-slip rib is configured to cover a top of the cross-section, and the anti-slip rib protrudes from the top of the cross-section.

3. The non-slip telephone cord hair tie as claimed in claim 1, wherein the elastic body is mad of transparent PVC (polyvinyl chloride), the anti-slip rib is made of a silicone material, and the anti-slip rib is integrally formed on the elastic body by dispensing.

4. The non-slip telephone cord hair tie as claimed in claim 1, wherein the two ends of the elastic body are joined by means of melt.
